(19) United States
(12) Patent Application Publication
(10) Pub. No.: US 2025/0251729 A1
(43) Pub. Date: Aug. 7, 2025

(54) MOBILE ROBOT POSITIONING SYSTEM

(71) Applicant: HITACHI, Ltd., Tokyo (JP)

(72) Inventor: Yuudai KAMADA, Mountain View, CA (US)

(73) Assignee: HITACHI, Ltd., (omitted)

(21) Appl. No.: 18/431,766

(22) Filed: Feb. 2, 2024

(51) Int. Cl. G05D 1/246; G05D 107/70

(52) U.S. Cl. CPC G05D 1/2462; G05D 2107/70

(57) ABSTRACT

Systems and methods that enhance the navigation of autonomous mobile robots in dynamic environments, such as inspection yards or manufacturing facilities in which positions and states of objects frequently change. This is achieved by integrating static maps, which provide information about permanent structures and areas, with dynamic maps, which focus on zones with movable objects and inspection zones where the robot performs tasks like monitoring or object inspection. Various embodiments utilize simultaneous localization and mapping (SLAM) techniques to generate maps that account for frequently changing elements in the environments. Real-time map generation and updates comprise splitting an environmental map into static and dynamic regions and calculating the robot's absolute position in the environment and its relative position to objects of interest. This dual estimation leverages different map datasets to perform efficient and accurate self-position estimation, thus ensuring consistent and reliable navigation based on real-time monitoring of the robot's surroundings.

### BACKGROUND

### Field

The present disclosure is generally directed to autonomous mobile devices, and more specifically, to automatic mobile robot positioning methods and systems for use in navigating tasks.

### Related Art

In recent years, the utilization of autonomous mobile robots in logistics, warehouse operations, and construction sites has advanced significantly. These robots primarily undertake tasks such as cargo transportation, arrangement, surveillance, and data collection. Moreover, mobile robots capable of quadrupedal movement have widened their applicability to tasks such as building maintenance, patrols, and inspections within warehouses or factories, navigating environments with stairs, steps, and uneven terrain. Leveraging sensors, cameras, and artificial intelligence, these robots operate autonomously and are capable of collaboration with humans. Additionally, the integration of cloud-based software and data analysis accelerates efforts to enhance efficiency and safety. Robots perform tasks such as product inspections and environmental surveillance in industrial fields, traditionally performed manually, using existing approaches, such as Simultaneous Localization and Mapping (SLAM). Common SLAM applications involve obtaining pre-created map data of a robot's surrounding environment to move autonomously from one point to another, while simultaneously estimating the robot's own position and updating the entire map. However, a major shortcoming of such approaches is that they do not account for potential changes in target location, such as changes in the precise location of an object on a manufacturing floor that, in practice, may vary, especially for relatively large objects. Therefore, it is desirable to have systems and methods that enable more accurate and reliable autonomous navigation in manufacturing and similar environments.

### SUMMARY

In some aspects of the present disclosure, map generation and navigation systems and methods increase navigation accuracy and efficiency for mobile robots or equivalent devices operating in environments having dynamically changing surroundings. One example implementation divides a global map into distinct segments: a first static map and a first dynamic map that includes inspection targets. After an initial division, a real-time global map is derived from both the initial global map and a set of external data obtained from a manufacturing system. A further division produces a second static map and a second dynamic map that comprises a target area. The second static map is used to estimate the absolute mobile device's position and the second dynamic map for estimating a relative mobile device position. These positions are then aligned to generate a combined map. The combined map represents an adjusted real-time global map, wherein the second dynamic map is aligned with the second static map, allowing for precise and effective navigation.

Aspects of the present disclosure involve using the combined map to autonomously update a navigation path associated with the target area, and use the absolute mobile device position, the relative mobile device position, or the combined map for performing various tasks, such as inspection and navigation. The global map can be a 3D map obtained from sensor data comprising point cloud data. The external data set may comprise data from a manufacturing execution system and other environmental information. The gathered data allows the mobile robot to comprehend the dynamic nature of its environment, which may include real-time status information about a set of objects, including their position or presence.

Aspects of the present disclosure involve map generation and navigation system that may comprise a map management system, a mobile robot control unit, an external system for data provision, and a robot. The map management system performs the initial division of the global map and creates the real-time global map. The mobile robot control unit may perform estimation steps that comprise estimating absolute and relative mobile device positions. The external system provides a set of external data to the map management system. Finally, the robot, equipped with sensors, aligns the absolute and relative positions to create the combined map and uses the resulting map for autonomous navigation and task execution.

Aspects of the present disclosure can involve additional features of the system, including the robot's ability to use the combined map to update navigation paths and perform inspection tasks; the integration of sensors for real-time data gathering; and the control of actuators by the mobile robot control unit. Further, the map management system may communicate with the external system for continual updates, ensuring the maps' relevance for navigation and task execution in environments with dynamic objects.

Aspects of the present disclosure can involve a navigation apparatus, which can involve means for dividing a global map into at least a first static map and a first dynamic map, the first dynamic map comprising an inspection target, using the global map as a reference map and a set of external data, which has been obtained from a manufacturing system, to create a real-time global map, and dividing the real-time global map to generate a second static map and a second dynamic map, the second dynamic map comprising a target area. A navigation system can involve means for using the second static map to estimate an absolute mobile device position, using the second dynamic map to estimate a relative mobile device position, and means for providing the set of external data to the map management system, in response to being queried, and means for aligning the absolute mobile device position and the relative mobile device position to generate a combined map that represents an adjusted real-time global map in which the second dynamic map is aligned with the second static map.

### BRIEF DESCRIPTION OF DRAWINGS

FIG. 1 illustrates an exemplary autonomous mobile robot in an inspection yard for railway vehicles.

FIG. 2 is a flowchart for an exemplary map generation for navigation based on dynamic maps, in accordance with an example implementation.

FIG. 3 illustrates an example process for using a map management system to generate a real-time global map in accordance with an example implementation.

FIG. 4 illustrates an example process for using a real-time global map to perform self-position estimation and navigation in a mobile robot operation in accordance with an example implementation.

FIG. 5 is a schematic illustrating an exemplary map generation and navigation flow in accordance with an example implementation.

FIG. 6 illustrates a map generation and navigation system for environments comprising dynamic objects in accordance with an example implementation.

FIG. 7 illustrates an example computing environment with an example computer device suitable for use in some example implementations.

### DETAILED DESCRIPTION

The following description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present disclosure. Selection can be conducted by a user through a user interface or other input means, or can be implemented through a desired algorithm. Example implementations as described herein can be utilized either singularly or in combination and the functionality of the example implementations can be implemented through any means according to the desired implementations. In this document, the terms “mobile robot” and “mobile device” are used interchangeably.

In manufacturing operations, production typically progresses according to planned processes in manufacturing execution systems. Visual inspections form a significant part of the production process, where assigned workers verify the visual characteristics of specific parts and input inspection results, advancing the process. These tasks are automatable with mobile robots. For instance, robots can receive inspection details and execution timings from cloud-based manufacturing execution systems, initiating inspections accordingly. Predefined inspection locations, routes, and criteria prompt the robot to autonomously move to inspection areas to acquire images and data using onboard cameras and sensors. Utilizing computer vision technology, the acquired data undergoes inspection, and results are fed back to the manufacturing execution system, automating the process.

Such use cases benefit from autonomous navigation technology that allows robots to autonomously move to desired locations based on inspection or surveillance needs, accomplish tasks like data acquisition, and return to their initial positions, e.g., charging stations.

To achieve autonomous navigation, self-localization techniques, such as SLAM, aid a robot to create a map of its environment and determine its own position within that environment. Using SLAM, robots or moving entities simultaneously estimate their positions and create maps of unknown environments, which involves two key objectives. The first key objective involves estimating the robot's position by using internal information and sensor information without relying on external data such as Global Positioning Satellite (GPS) data. The second key objective involves mapping the environment traversed by the robot, creating a map utilizing sensor data even in unknown environments. Various sensors are used in SLAM, including cameras, Light Detection and Ranging (LIDAR), ultrasound sensors, and Inertial Measurement Units (IMUs).

One challenge in navigation using SLAM is adapting to dynamic environments. In complex real-world settings, the positions of surrounding objects or obstacles can change, and movable entities such as people or other mobile objects may be present. Particularly in factories or warehouses, it is anticipated that the positions of objects may change rapidly during production or logistics operations. To execute accurate navigation in such dynamically changing environments, some approaches partition pre-created maps into multiple layers, individually matching data from each layer with measurement data from the robot's current position, and utilizing superior matching results to estimate self-position. However, existing approaches do not utilize map data from rapidly changing dynamic areas, but merely leverage static features to achieve precise navigation.

Further, such methods assume that the target location, inspection sites, and similar objects of interest are static and do not significantly differ from the pre-existing data. In other words, even if there are significant environmental changes during the robot's movement toward the target object, it can accurately determine its own position and reach the destination. However, this does not hold true if the target object itself undergoes dynamic changes.

In product inspections in a factory setting for mass-produced items, for example, it is common to inspect products that move along predefined a manufacturing line by using fixed cameras. Inspection timings are uniquely determined, thus, eliminating the need for flexibility in inspection locations or timings. Additionally, the inspected objects are often small in size and can be inspected using one or a few cameras. Therefore, recognizing the inspected objects within predefined frames and conducting inspections suffices.

On the other hand, inspections using mobile robots often involve use cases that do not align with the aforementioned scenarios. For instance, in the inspection of large objects such as automobiles, railway vehicles, or the assembly inspection of large furniture and prefabricated structures, there are numerous inspection points, and the inspection scope is diverse. Using fixed cameras to address these scenarios would require an extensive number of cameras due to the multitude of inspection locations. Additionally, depending on the inspection requirements, there are areas, such as underfloor spaces or confined spaces, that pose physical challenges to human access. In cases where physical strain on humans is substantial and inspections involve multiple diverse locations, there is a potential use case for automating these inspections with mobile robots. A significant distinction from inspections using fixed cameras is that the robot itself needs to accurately navigate to the inspection locations.

In such scenarios, there arises a need to navigate toward the destination relying on maps generated using technologies like SLAM. However, the destination constitutes the position of the inspection target, typically products or conveyed items in production, which means the spatial relation would not perfectly match the map generated beforehand. For instance, maps that have been created by utilizing point clouds achieve millimeter-level accuracy. Therefore, even if inspection locations were predetermined, expecting the inspection target to be located precisely in the same place at a millimeter-level accuracy each time is unrealistic. Consequently, discrepancies emerge between the self-positioning based on an understanding of the inspection target and the self-positioning based on static objects like pillars, walls, or manufacturing machinery.

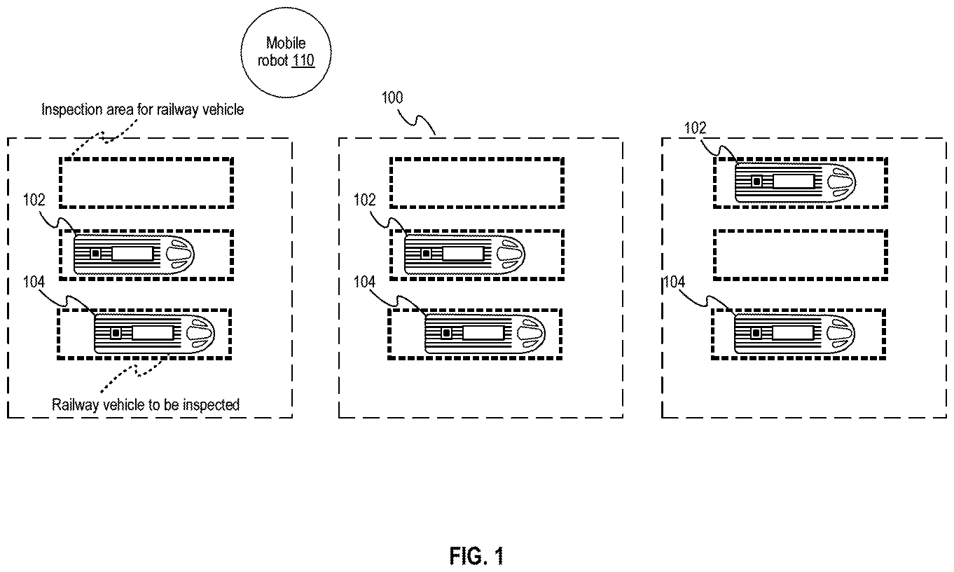

FIG. 1 illustrates an exemplary autonomous mobile robot in an inspection yard for railway vehicles. Depicted are inspection yard 100, railway vehicles 102, 104, and mobile robot 110. Inspection yard 100 is intended to hold relatively large products such as railway vehicles 102 and 104 that are arranged parallel to each other. Oftentimes, arrangements, i.e., the absolute and or relative positions of objects to each other and to mobile robot 110, may vary based on manufacturing conditions. For instance, assuming inspection yard 100 is capable of accommodating up to five vehicles, the vehicle arrangement during the map generation might not match the actual arrangement during the inspection process by mobile robot 110, e.g., due to the substantial size of vehicles 102, 104 compared to mobile robot 110. As a result, point cloud data perceived by mobile robot 110 may differ significantly based on the presence or absence of other vehicles at their assigned target areas and positioning therein. As an example, when there is a need to move between vehicles 102 and 104, the environment perceived by a mobile robot 110 will differ significantly depending on whether vehicles are present on both sides or only on one side. In such scenarios, even if the global map available to mobile robot 110 is divided into multiple layers, as is common in SLAM applications, accurate self-positioning and navigation of mobile robot 110 cannot be guaranteed.

Therefore, various systems and methods disclosed herein are aimed at overcoming the shortcomings of existing autonomous navigation in manufacturing and other environments. In embodiments, this is accomplished by increasing the accuracy of navigation systems and methods for mobile robots that operate in environments prone to change, especially where target objects themselves can move or change states. Various embodiments operate without relying on extensive measurement data and are particularly effective in scenarios where mobile robots, such as quadruped robots, drones, and automated guided vehicles, inspect and pick up objects or collect image and sensing data.

In embodiments, navigation takes advantage of mainly two self-position estimations, one that involves acquiring an absolute position of the mobile robot in a given environment and another self-position estimation that involves acquiring a relative position to objects of interest, such as those involved in inspection or monitoring. Estimations are performed using different map datasets, and the integration of the maps ensures the consistency of each self-position estimation across a unified map dataset, thus, enabling effective navigation in these scenarios.

As discussed further below, various embodiments utilize data from external systems such as manufacturing execution systems. This enables the selection and utilization of map information depending on environmental conditions. Self-position estimation results obtained using different map data may be aligned with a relatively small measurement data set, thereby avoiding the need to remap or update an entire map each time the environment changes.

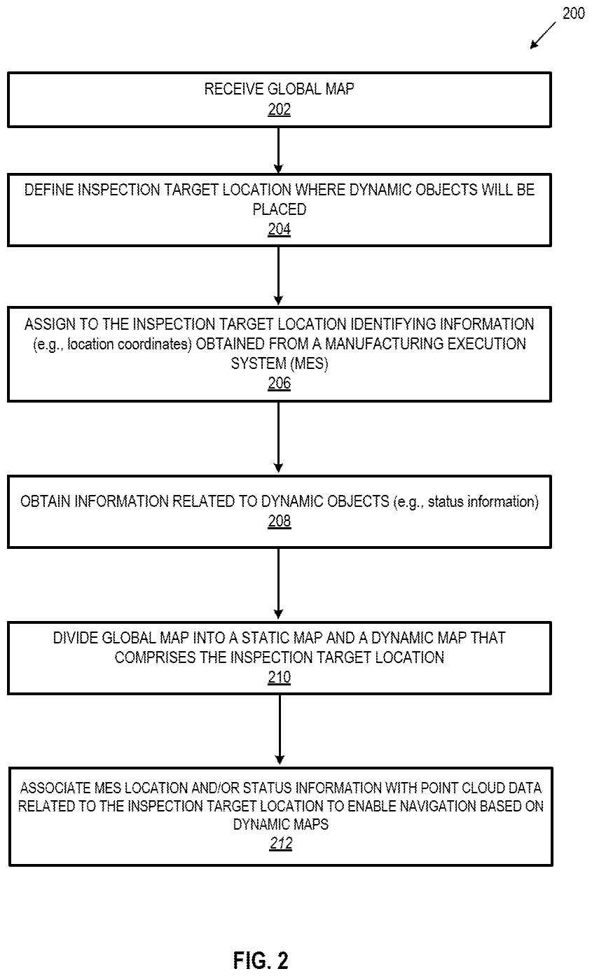

FIG. 2 is a flowchart for an exemplary map generation for navigation based on dynamic maps, in accordance with an example implementation. Process 200 begins when, at step 202 a global map is generated. This may be accomplished using any map generation and trajectory estimation method known in the art. To execute navigation based on dynamic objects, it is helpful to accurately update a reference map based on real-time information and conduct self-positioning estimation based on the updated map. In this context, “dynamic object” refers not necessarily to objects that dynamically change at the time of robot operation but rather to those objects undergoing changes when compared to past situations. This could indicate variations from previous instances, even within the same category of objects, such as inspection vehicles, where individual instances might differ from the past.

It is noted that map generation using a typical SLAM approach comprises a mobile robot having sensors (cameras, Lidar, etc.) that acquire environmental data during movement, extract features from the gathered data, and establish correspondences between points at different times and positions. This allows for tracking the movement of features alongside the robot's motion and for estimating the robot's pose. Based on the estimated pose, the measured data is then used to update the map along the robot's path. However, since the robot estimates its self-position and simultaneously constructs the environmental map, errors accumulate in the estimated position and the map. To correct for such errors, techniques such as loop detection are employed. Once the robot revisits a previous location, observing the same features triggers loop detection, which facilitates global optimization of the map and the robot's self-position estimation using available data, including past observations. Iterating these steps enables the construction of the environmental map and tracking of pose changes and trajectories during movement.

In contrast to such existing SLAM techniques, an environmental map, received at step 202, is split into two types of areas or regions. One encompasses structures like walls, pillars, and fixtures, such as corridors and stationary machinery. That region's map information is referred to herein as “static map.” It is noted that the term “static” does not imply a complete absence of change, rather it intends to differentiate from dynamic objects targeted by the mobile robot, which account for scenarios like human or mobile object presence and potential shifts in items or fixtures.

The second type of area may be defined, e.g., at step 204, by inspection target locations in the global map at which dynamic objects may be placed, with their presence and positions subject to change based on circumstances. The map information associated with this region or area is herein denoted as the “dynamic map.” For clarity, this area will be referred to as “inspection zone.” While an inspection zone's state may vary over time and space, the presence or absence of objects, their types, and conditions are typically not entirely unknown. It is noted that the map management system may receive the environmental map in the form of a 3D map comprising information, e.g., sensor data gathered by a mobile robot. Stated differently, static and dynamic maps may be generated from a global map that may have been created using SLAM or similar methods

At step 206, the map management system may assign to the inspection target location, location-related information that may have been obtained from manufacturing execution systems (MESs) in factories or warehouses that maintain dynamic map information such as location IDs or keywords that uniquely identify the inspection target location.

At step 208, the map management system may further obtain from the MES information identifying individual dynamic objects, including their types, assembly status, and other details and assign those to the inspection target location.

At step 210, the map management system may use one or more inspection zones to divide the environmental map (for simplicity, referred to herein as “global map”) into a static map and a dynamic map, which comprises the inspection target location. For clarity, it is assumed that the inspection zones, where the mobile robot performs actions like inspection or monitoring, are predetermined and identifiable by some form of ID or keyword. Each inspection zone has a defined area within which dynamic objects might be located, and there can be multiple inspection zones. As each inspection zone's range can be uniquely defined, it corresponds on a one-to-one basis with coordinates within the global map. Consequently, the positions of each inspection zone defined within the generated global map can be established.

At step 212, the MES location and/or status information may be linked to point cloud data related to the inspection target location to enable navigation based on dynamic maps. It is understood that dynamic maps may be stored separately from static maps, e.g., as dynamic map reference data. It is further understood that although examples herein are provided in the context of point cloud data, this is not intended as a limitation on the scope of the present disclosure. One skilled in the art will appreciate that other mapping methods, such as camera-based techniques may be employed to achieve the objectives of the present disclosure.

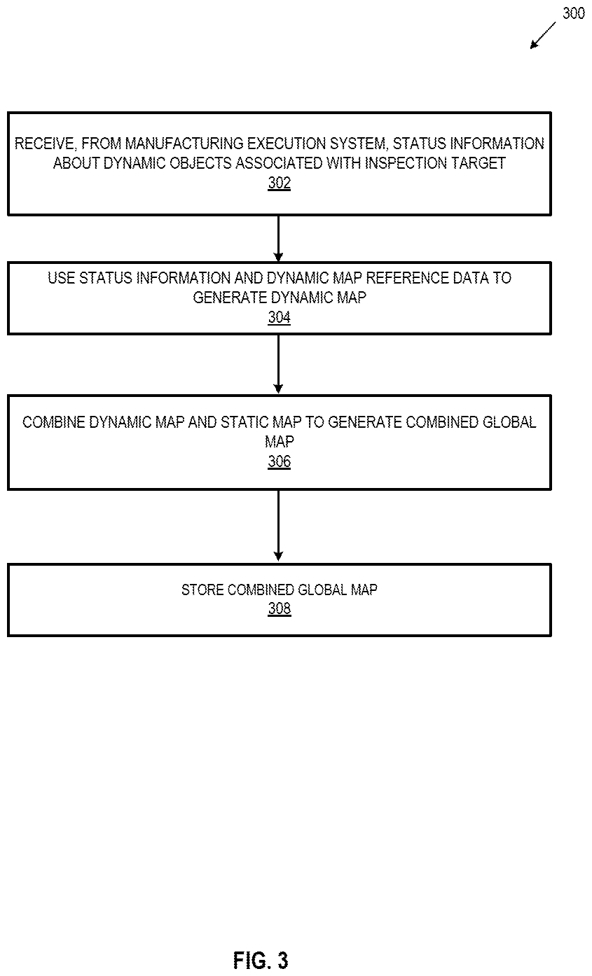

Once a correspondence between identification information denoting locations within the MES and coordinates within the global map is maintained, information representing individual dynamic objects and their statuses may be extracted from the MES to create a real-time global map that comprises a dynamic target area for target objects. FIG. 3 illustrates an example process for using a map management system to generate a real-time global map in accordance with an example implementation.

As shown in FIG. 3, process 300 for generating a real-time global map may begin, at step 302, e.g., prior to the mobile robot's operation, when status information about dynamic objects associated with an inspection target is obtained from an MES system.

At step 304, based on the status information, dynamic map reference data may be obtained, e.g., selected from a set of dynamic map data, to identify and generate a dynamic map. It is noted that the static and dynamic maps may serve different purposes. For example, the static map is utilized to ascertain the absolute coordinates of the robot's current position, while dynamic maps are used to determine relative positions of dynamic objects in their inspection zones.

At step 306, the generated dynamic map may be combined with the static map to generate a real-time global map that, at step 308, may be stored for further processing. It is noted that more than one dynamic map may be extracted and combined with the static map to generate the real-time global map, which may be also viewed as virtual or temporary map.

Once a real-time map has been generated, it may be used as a self-updating reference, which involves simultaneous self-position estimation and navigation, utilizing real-time data during the robot's operation. This process successfully reduces uncertainties associated with dynamic objects in the environment. The integration and coordination with MES provide access to accurate data on dynamic object positions and their point cloud representations.

Unlike conventional systems that necessitate time and labor-intensive complete remappings for each robot operation, embodiments herein utilize baseline data to estimate the relative positions of dynamic objects, thereby requiring minimal on-site data collection. This not only simplifies the generation of point cloud data for dynamic objects but also significantly improves navigation accuracy and speed. Although the data might not precisely replicate the on-site conditions, it enables more accurate and faster navigation, enhancing the efficiency of tasks like inspection and surveillance.

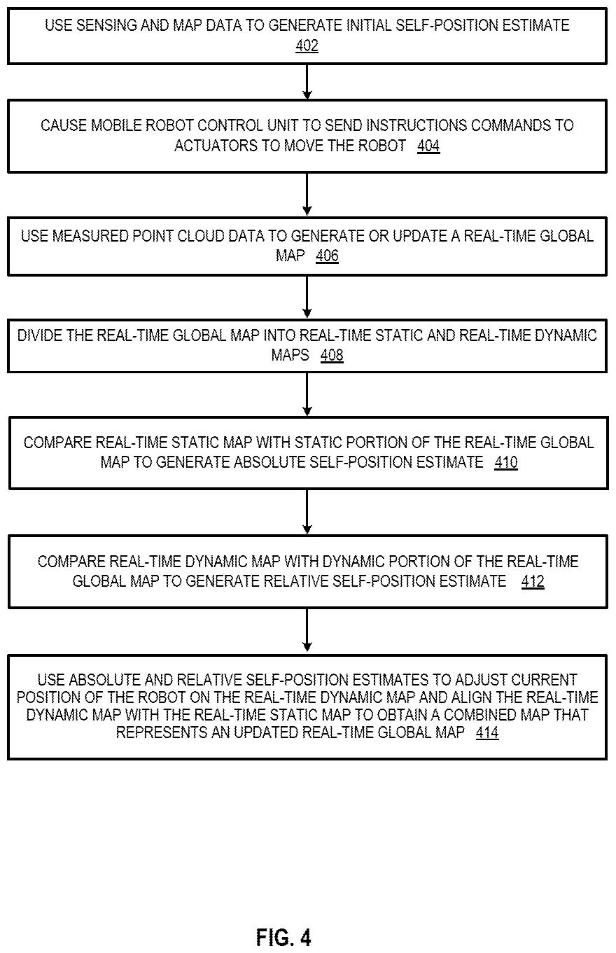

FIG. 4 illustrates an example process for using a real-time global map to perform self-position estimation and navigation in a mobile robot operation in accordance with an example implementation. At the start of operation 402, the mobile robot utilizes a combination of a static map, any number of dynamic maps, measured point cloud or image data, and other information to estimate its own position. Such initial self-position estimation can be derived from predefined values, matching outcomes with the virtual global map, through the use of QR codes, and the like.

At step 404, a mobile robot control unit may communicate commands to an actuator to cause the actuator to execute a predefined movement.

At 406, the mobile robot control unit may cause a robot to measure point cloud data of the robot's surroundings similar to conventional SLAM operations to generate or update the real-time global map along the robot's path during operation.

At step 408, based on the updated self-position data comprising predefined area information, the real-time global map is divided into static and dynamic maps. To distinguish them from those maps created from the global map discussed with reference to FIG. 2, they are referred to as “real-time static map” and “real-time dynamic map,” respectively.

At step 410, a comparison between the real-time static map and real-time global map, i.e., the static portion of the real-time global map, is used to generate an absolute self-position estimate that provides precise and reliable coordinates within the environment.

Conversely, at step 412, the real-time dynamic map is compared against the dynamic portion of the real-time global map to generate a relative self-position estimate. The self-position estimated from the real-time dynamic map is handled as a relative positional coordinate with respect to dynamic objects. This distinction arises since the dynamic portion of the real-time global map is assumed to have conditions and object placements similar to those during prior mapping. Thus, the comparison helps in identifying and correcting discrepancies in absolute positioning.

Using the estimated absolute position from the real-time static map as a reference, corrections can be made to the positional relation between the static map and the dynamic map based on the relative positions of dynamic objects estimated from the real-time dynamic map. This process enables the estimation of the expected positions of the previously constructed real-time dynamic map based on the measurement data obtained during the operation of the mobile robot.

Finally, at step 414, an adjustment unit may use the absolute self-position estimate and the relative self-position estimate to adjust the current position of the robot on the real-time dynamic map and align the real-time dynamic map with the real-time static map to obtain a combined map where the absolute and relative self-positions from both maps overlap. The combined map represents an updated real-time global map that enables navigation with significantly increased navigation accuracy, thus ensuring the robot's precise and efficient movement in environments having dynamic targets.

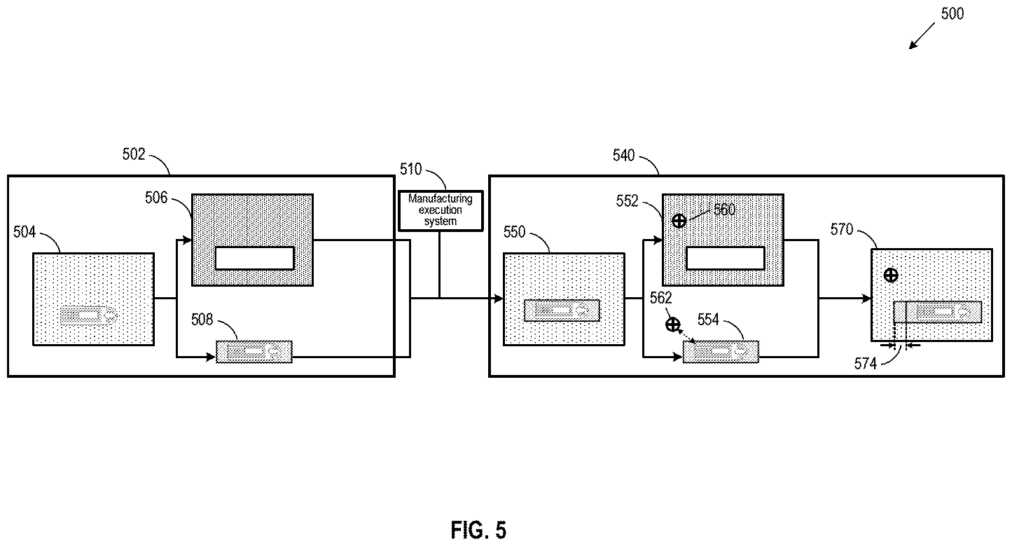

FIG. 5 is a schematic illustrating an exemplary map generation and navigation flow in accordance with an example implementation. Schematic 500 comprises map generation 502 and map operation 540. In example implementations, map generation 502 comprises global map 504, static map 506, and dynamic map 508. Map operation 540 comprises real-time global map 550, which comprises real-time static map 552 and real-time dynamic map 554, and from which a combined map 570 is created.

As depicted in FIG. 5, during map generation, global map 504 may be divided into static map 506 and dynamic map 508. Global map 504 may be a 3-D map that has been obtained by using sensor data that comprises point cloud data. Dynamic map 508 may comprise an inspection target or some other location of interest. Once global map 504 has been generated, in operation, external data 510, e.g., environmental information comprising real-time status information related to a set of movable objects may be obtained from a cloud-based MES and combined with the global map 504 to generate real-time global map 550. In example implementations, real-time global map 550 may be split into real-time static map 552 and real-time dynamic map 554, which comprises a target area. Real-time static map 552 may be used to estimate an absolute mobile device position 560, whereas real-time dynamic map 554 may be used to estimate relative mobile device position 562. As a final step, absolute mobile device position 560 and relative mobile device position 562 may be aligned, e.g., by shifting them relative to each other by a calculated amount 574, to generate combined map 570 that may be viewed as an adjusted real-time global map. Combined map 570 may then be used, for example, to autonomously update a navigation path associated with the target data or to perform an inspection navigation task.

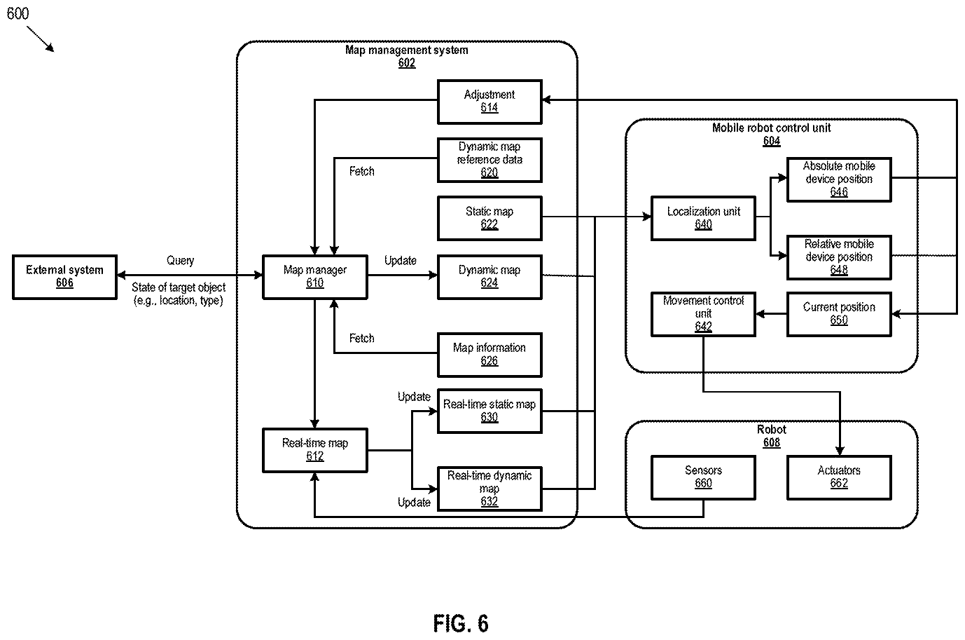

FIG. 6 illustrates a map generation and navigation system for environments comprising dynamic objects in accordance with an example implementation. As previously mentioned, a map management system 602 may maintain four types of maps (static map, dynamic map, real-time static map, real-time dynamic map). The map management unit manages and updates details of at least some of the maps. In embodiments, the map management unit acquires, e.g., from external systems, e.g., an MES, information about the location and type of target dynamic objects. The map management unit may extract corresponding target reference data that matches the location and/or type information, updating the dynamic map accordingly. Additionally, using the data gathered from the robot, the map management unit divides the generated or updated real-time map into a real-time static map and a real-time dynamic map.

The robot control unit is equipped with the capability to estimate its own position using information associated with at least some of the four types of maps. For example, the robot control unit may comprise functionality to estimate global coordinates using the information from the static map and the real-time static map. Similarly, the robot control unit may comprise functionality to estimate coordinates relative to dynamic objects by using the dynamic map and the real-time dynamic map. These two estimation sets may be shared with the adjustment unit in the map management system, which is utilized for fine-tuning the dynamic map using the described method. Additionally, the two sets of estimations may be used to deduce the robot's current position and generate operational control signals.

The generated control signals are transmitted to the mobile robot and reflected in its actual operations through the actuators. In operation, the mobile robot may measure the surrounding environment using cameras and sensors and send data to the map management system. The map management system utilizes the collected data, to generate and update the local map in real-time. Through this iterative process of data collection, analysis, and map updating, the mobile robot can efficiently navigate and perform designated tasks, while adapting to dynamic environmental conditions with enhanced precision and effectiveness.

System 600 comprises map management system 602, mobile robot control unit 604, external system 606, and robot 608. External system 606 may be a MES, as described above, e.g., with reference to FIG. 2. In operation, external system 606 may be queried by map management system 602 to provide information regarding the state of a target dynamic object, such as its location or type. As depicted in FIG. 6, map management system 602 comprises map manager 610 that communicates with real-time map unit 612 and adjustment unit 614 within map management system 602. Map management system 602 may obtain dynamic map reference data 620, static map data 622, dynamic map data 624, and any other type of data such as map information 626 to update dynamic map data 624. Map manager 610 further communicates with real-time map unit 612 that, in response to receiving sensor data 660 from robot 608, generates and/or updates real-time static map 630 and real-time dynamic 632.

In response to receiving data provided by map management system 602, e.g., at localization unit 640, mobile robot control unit 604 may estimate an absolute mobile device position 646 and a relative mobile device position 648 and provide the results to adjustment unit 614 in that management system 602. The results may further be used to determine a current position 650 of robot 608. Current position 650 may then be used by movement control unit 642 to send commands to actuators 662 to navigate robot 608. Sensor data 660 generated by robot 608 may be fed back to real-time map unit 612 in management system 602 to update respective real-time static map 630 and real-time dynamic map 632, as described above, e.g., with reference to FIG. 2 and FIG. 4.

By dividing predefined areas into static and dynamic maps and collaborating with external systems, such as an MES, embodiments herein enable real-time estimates of changing scenarios within a dynamic map. Consequently, the overall map can be accurately updated without the need to fully remap the entire dynamic map. As a result, systems and methods herein enable precise determination of a mobile robot's positional relation to dynamic objects using minimal measurements. This accelerates the robot's execution of various actions such as inspection and monitoring. Additionally, the integration with MES, enables the preparation and management of multiple dynamic maps, facilitating the handling of multiple inspection zones and extensive mapping operations. Simultaneously, through collaboration with information identifying individual dynamic objects, systems can appropriately select an appropriate dynamic map for each scenario. By combining these effects, systems and methods enable precise and efficient guidance of mobile robots even in dynamic environments like factory floors or logistics areas where the positions and conditions of objects are subject to constant change.

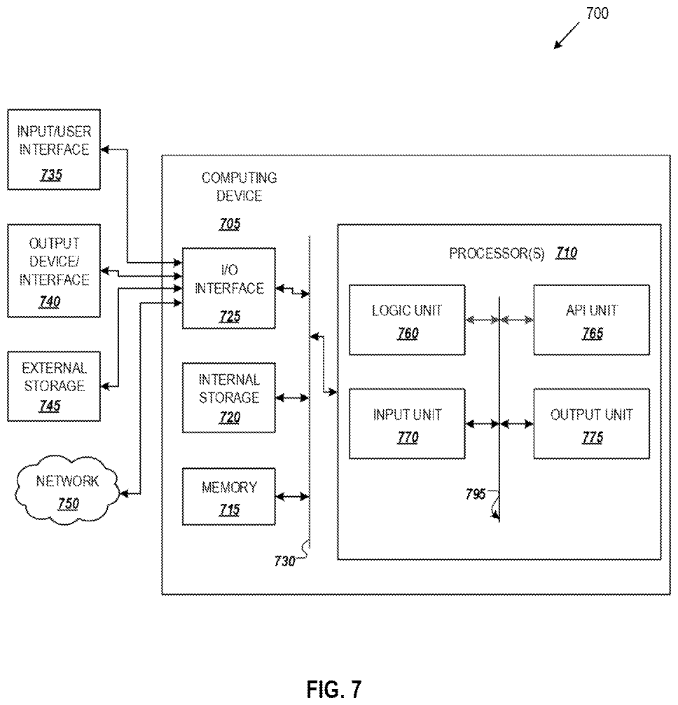

FIG. 7 illustrates an example computing environment with an example computer device suitable for use in some example implementations, such as the map generation and navigation system in FIG. 6, and can serve as the platform to facilitate the functionality for map management system 602 or mobile robot control unit 604. Computing device 705 in computing environment 700 can include one or more processing units, cores, or processors 710, memory 715 (e.g., read access memory (RAM), read-only memory (ROM), and/or the like), internal storage 720 (e.g., magnetic, optical, solid-state storage, and/or organic), and/or input/output (I/O) interface 725, any of which can be coupled on a communication mechanism or bus 730 for communicating information or embedded in the computing device 705.

Computing device 705 can be communicatively coupled to input/user interface 735 and output device/interface 740. Either one or both of input/user interface 735 and output device/interface 740 can be a wired or wireless interface and can be detachable. Input/user interface 735 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 740 may include a display, television, monitor, printer, speaker, braille, or the like. In some example implementations, input/user interface 735 and output device/interface 740 can be embedded with or physically coupled to the computing device 705. In other example implementations, other computing devices may function as or provide the functions of input/user interface 735 and output device/interface 740 for a computing device 705.

Examples of computing device 705 may comprise highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computing device 705 can be communicatively coupled (e.g., via I/O interface 725) to external storage 745 and network 750 for communicating with any number of networked components, devices, and systems, including one or more computing devices of the same or different configurations. Computing device 705 or any connected computing device can be functioning as, providing services of, or referred to as a server, client, thin server, general machine, special-purpose machine, or another label.

I/O interface 725 may comprise wired and/or wireless interfaces using any communication or I/O protocols or standards (e.g., Ethernet, 702.11x, Universal System Bus, WiMax, modem, a cellular network protocol, and the like) for communicating information to and/or from at least all the connected components, devices, and network in computing environment 700. Network 750 can be any network or combination of networks (e.g., the Internet, local area network, wide area network, a telephonic network, a cellular network, satellite network, and the like).

Computing device 705 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computing device 705 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 710 can execute under any operating system, in a native or virtual environment. One or more applications can be deployed that include logic unit 760, application programming interface (API) unit 765, input unit 770, output unit 775, and inter-unit communication mechanism 795 for the different units to communicate with each other, with the OS, and with other applications (not shown). The described units and elements can be varied in design, function, configuration, or implementation and are not limited to the descriptions provided. Processor(s) 710 can be in the form of hardware processors such as central processing units (CPUs) or a combination of hardware and software units.

In some example implementations, when information or an execution instruction is received by API unit 765, it may be communicated to one or more other units (e.g., logic unit 760, input unit 770, output unit 775). In some instances, logic unit 760 may be configured to control the information flow among the units and direct the services provided by API unit 765, input unit 770, and output unit 775, in some example implementations described above. For example, the flow of one or more processes or implementations may be controlled by logic unit 760 alone or in conjunction with API unit 765. The input unit 770 may be configured to obtain input for the calculations described in the example implementations, and the output unit 775 may be configured to provide output based on the calculations described in example implementations.

In implementations where computing device 705 serves as the map management system 602, processor(s) 710 can be configured to execute a method or instructions involving dividing a global map into at least a first static map and a first dynamic map, which may be associated with different times, the first dynamic map comprising an inspection target, wherein the global map is a 3D map that has been obtained by using sensor data comprising point cloud data; using the global map as a reference map and a set of external data, which has been obtained from a manufacturing system and reflects environmental information, which may comprise status information related to a set of objects and comprising at least one of a position or presence of an object in the set of objects, and/or a signal, a file, or an environmental state, to create a real-time global map; dividing the real-time global map to generate a second static map and a second dynamic map, the second dynamic map comprising a target area; using the second static map to estimate an absolute mobile device position; using the second dynamic map to estimate a relative mobile device position; and aligning the absolute mobile device position and the relative mobile device position to generate a combined map that represents an adjusted real-time global map in which the second dynamic map is aligned with the second static map, as described with respect to FIG. 4.

Processor(s) 710 can be configured to execute a method or instructions involving autonomously updating a navigation path associated with the target data or to perform an inspection navigation task or a navigation task. Based on the determination, processor(s) 710 can communicate instructions to a robot control unit, as described with respect to FIG. 6, to cause the mobile robot to efficiently navigate and perform designated tasks, e.g., by using the absolute and relative mobile device position or the combined map.

Processor(s) 710 can further be configured to execute a method or instructions involving generating maps for navigation by utilizing dynamic maps, as described with respect to FIG. 2. A real-time global map may be generated, as described with respect to FIG. 3, and may be used to perform self-position estimation and navigation in a mobile robot operation, as described with respect to FIG. 4. As described with respect to FIG. 5, processor(s) 710 can be configured to execute a method or instructions involving utilizing external MES data, such as an identifier or a keyword, e.g., as described with respect to FIG. 2.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computing system or other information processing device that manipulates and transforms data represented as physical (electronic) quantities within the computing system's registers and memories into other data similarly represented as physical quantities within the computing system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices, and drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., CPUs, processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or they can be spread across a number of components in any number of ways. When performed by software, the methods may be executed by a processor, such as a general-purpose computer, based on instructions stored on a computer-readable medium. If desired, the instructions can be stored in the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for navigating in environments comprising dynamic objects, the method comprising:
dividing a global map into at least a first static map and a first dynamic map, the first dynamic map comprising an inspection target;
using the global map as a reference map and a set of external data, which has been obtained from a manufacturing system, to create a real-time global map;
dividing the real-time global map to generate a second static map and a second dynamic map, the second dynamic map comprising a target area;
using the second static map to estimate an absolute mobile device position;
using the second dynamic map to estimate a relative mobile device position; and
aligning the absolute mobile device position and the relative mobile device position to generate a combined map that represents an adjusted real-time global map in which the second dynamic map is aligned with the second static map.

2. The method according to claim 1, further comprising using the combined map to autonomously update a navigation path associated with the target area.

3. The method according to claim 1, further comprising using at least one of the absolute mobile device position, the relative mobile device position, or the combined map to perform at least one of an inspection task or a navigation task.

4. The method according to claim 1, wherein the global map is a 3D map that has been obtained by using sensor data comprising point cloud data.

5. The method according to claim 1, wherein the set of external data comprises data received from a manufacturing execution system and reflects environmental information.

6. The method according to claim 5, further comprising receiving at least one of a signal, a file, or an environmental state.

7. The method according to claim 5, wherein the environmental information comprises status information related to a set of objects.

8. The method according to claim 7, wherein the status information comprises at least one of a position or presence of an object in the set of objects.

9. The method according to claim 1, wherein the first static map is associated with a different time than the first dynamic map.

10. The method according to claim 1, further comprising assigning at least one of an identifier or a keyword to at least one of the target area or an object associated with the target area.

11. The method according to claim 1, wherein identifier or keyword is obtained from the set of external data.

12. A navigation system for environments comprising dynamic objects, the system comprising:
a map management system configured to:
divide a global map into at least a first static map and a first dynamic map, the first dynamic map comprising an inspection target;
using the global map as a reference map and a set of external data, which has been obtained from a manufacturing system, to create a real-time global map; and
divide the real-time global map to generate a second static map and a second dynamic map, the second dynamic map comprising a target area;
a mobile robot control unit configured to:
use the second static map to estimate an absolute mobile device position; and
use the second dynamic map to estimate a relative mobile device position;
an external system that, in response to being queried, provides the set of external data to the map management system; and
a robot that configured to align the absolute mobile device position and the relative mobile device position to generate a combined map that represents an adjusted real-time global map in which the second dynamic map is aligned with the second static map.

13. The navigation system according to claim 12, wherein the external system comprises systems for processing and transmitting data associated with dynamic elements in an environment.

14. The navigation system according to claim 12, wherein the set of external data comprises data received from a manufacturing execution system and reflects environmental information.

15. The navigation system according to claim 14, wherein the environmental information comprises real-time status information related to a set of objects, the real-time status information comprising at least one of a position of presence of an object in the set of objects.

16. The navigation system according to claim 12, wherein the robot is configured to use the combined map to autonomously update a navigation path associated with the target area.

17. The navigation system according to claim 12, wherein the robot comprises sensors to gather data for updating the global map in real-time based on changes in object positions and statuses.

18. The navigation system according to claim 12, wherein the robot comprises actuators that are controlled by the mobile robot control unit.

19. The navigation system according to claim 12, wherein the map management system is further configured to communicate with the external system to update at least one of the first dynamic map or the second dynamic map.

20. The navigation system according to claim 12, wherein the robot is configured to use at least one of the absolute mobile device position, the relative mobile device position, or the combined map to perform at least one of an inspection task or a navigation task.
